(19) United States
(12) Patent Application Publication
(10) Pub. No.: US 2005/0210654 A1
(43) Pub. Date: Sep. 29, 2005

(54) Method and apparatus for joining plates by caulking

(75) Inventors: Noriaki Kawauchi, Kanagawa (JP); Akihiko Satou, Yokohama (JP)

Correspondence Address: FOLEY AND LARDNER;SUITE 500, 3000 K STREET NW, WASHINGTON, DC, 20007, US

(73) Assignee: NISSAN MOTOR CO., LTD.

(21) Appl. No.: 11/079,267

(22) Filed: Mar. 15, 2005

(30) Foreign Application Priority Data
Mar. 26, 2004 (JP) 2004-092928

(51) Int. Cl. F16H 35/18; B23P 11/00

(52) U.S. Cl. 29/509; 29/505; 29/715

(57) ABSTRACT

A caulking method for joining a first plate having a tapered hole and a hollow cylindrical caulking portion extending from a periphery of the tapered hole, and a second plate having a hole, the method including inserting the caulking portion of the first plate through the hole of the second plate to project a tip end portion of the caulking portion beyond the hole and overlay the second plate on the first plate, and folding back the tip end portion of the caulking portion over a periphery of the hole of the second plate on one side surface thereof, while pressing against a beveled surface defining the tapered hole so as to prevent a material of the caulking portion from flowing toward the other side surface of the first plate along the periphery of the tapered hole.

### BACKGROUND OF THE INVENTION

The present invention relates to a method and apparatus for joining plates by caulking.

In order to join at least two plates together, caulking has been widely used as well as welding. Japanese Patent Application First Publication No. 11-239834 discloses a method for caulking metal plates. Caulking is advantageous in comparison with welding in that the facility cost and the number of processes are reduced.

Caulking a first plate and a second plate is carried out in the following manner. First, the first plate having a hole and a hollow cylindrical caulking portion extending from a periphery of the hole is prepared. The caulking portion of the first plate is formed by burring. The second plate having an insertion hole for receiving the caulking portion of the first plate is prepared. The second plate is overlaid on the first plate by inserting the caulking portion of the first plate into the insertion hole of the second plate. Then, the first plate is fastened to the second plate by folding back a tip end portion of the caulking portion over a periphery of the insertion hole on one side surface of the second plate.

### SUMMARY OF THE INVENTION

The joining strength provided by caulking varies greatly depending on an amount of overlapping of the folded-back tip end portion of the caulking portion of the first plate over the periphery of the insertion hole of the second plate, namely, a so-called lap amount of the folded-back tip end portion of the caulking portion. In order to increase the lap amount, it is necessary to increase a projecting amount of the caulking portion which projects from a surface of the first plate. However, in such a case, a diameter of a bore of the caulking portion will be inevitably increased depending on the burring ratio. Accordingly, if a diameter of the holes formed on the plates must be reduced from the viewpoint of the layout or overall strength of the product, caulking cannot be used at the caulking portion.

There is a demand to provide a technology for joining plates by caulking which can ensure a sufficient joining strength by providing a sufficient lap amount even when a hole of a plate has a relatively small diameter.

It is an object of the present invention to provide a technology for joining plates by caulking which can ensure a sufficient joining strength by providing a sufficient lap amount even when a bore of a caulking portion of the plate has a relatively small diameter.

In one aspect of the present invention, there is provided a caulking method for joining a first plate having a tapered hole tapered toward one side surface thereof and defined by a beveled surface, and a hollow cylindrical caulking portion extending from a periphery of the tapered hole on the one side surface, and a second plate having a hole, the caulking method comprising:
inserting the hollow cylindrical caulking portion of the first plate through the hole of the second plate to project a tip end portion of the hollow cylindrical caulking portion beyond the hole and overlay the second plate on the first plate; and
folding back the tip end portion of the hollow cylindrical caulking portion of the first plate over a periphery of the hole of the second plate on one side surface thereof, while pressing against the beveled surface of the first plate so as to prevent a material of the hollow cylindrical caulking portion from flowing toward the other side surface of the first plate along the periphery of the tapered hole.

In a further aspect of the present invention, there is provided a caulking apparatus for joining a first plate having a tapered hole tapered toward one side surface thereof and defined by a beveled surface with an inside edge and an outside edge, and a hollow cylindrical caulking portion extending from a periphery of the tapered hole on the one side surface, and a second plate having a hole, the caulking apparatus comprising:
a caulking unit comprising:
   a caulking punch axially moveably disposed; and
   a support die having a tapered portion for pressing against the beveled surface of the first plate, the support die being disposed substantially in axial alignment with the caulking punch and axially moveable to be inserted into the tapered hole of the first plate,
   the caulking punch and the support die cooperating with each other to fold back a tip end portion of the hollow cylindrical caulking portion which projects beyond the hole of the second plate, over a periphery of the hole of the second plate on the one side surface thereof, while pressing against the beveled surface of the first plate so as to prevent a material of the hollow cylindrical caulking portion from flowing toward the other side surface of the first plate along the periphery of the tapered hole.

### BRIEF DESCRIPTION OF THE DRAWINGS

FIG. 1A is a perspective view of a vehicular panel formed by a method of joining two plates, according to the present invention.

FIG. 1B is a section of the vehicular panel, taken along line 1B-1B shown in FIG. 1.

FIGS. 2A-2C are explanatory diagrams illustrating a burring step of the method of the present invention, showing a section of a burring unit of a caulking apparatus used in the method.

FIGS. 3A-3B are explanatory diagrams illustrating a caulking step of the method of the present invention, showing a section of a caulking unit of a first embodiment of the caulking apparatus.

FIG. 4A is an explanatory diagram illustrating function of the present invention, showing a section of an important portion of the caulking unit of the present invention.

FIG. 4B is an explanatory diagram illustrating function of a comparative example, showing a section of an important portion of a caulking unit of the comparative example.

FIG. 5 is a diagram similar to FIG. 3B, but showing a section of a caulking unit of a second embodiment of the caulking apparatus.

### DETAILED DESCRIPTION OF THE INVENTION

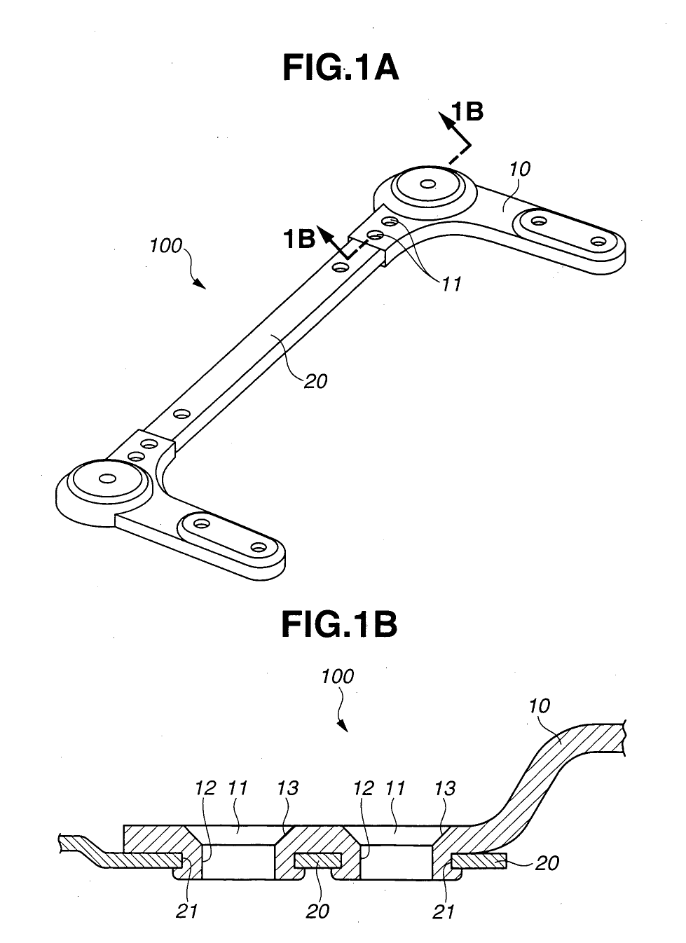

In the followings, embodiments of the present invention will be described with reference to the accompanying drawings. For ease of understanding, various directional terms, such as upper, lower, upward, downward and the like, are used in the following description. However, the terms denote the directions merely in the drawings. Referring to FIGS. 1A-1B, a first embodiment of the present invention is explained. As illustrated in FIG. 1A, vehicular panel 100 includes two plates 10 and 20 joined with each other. As illustrated in FIG. 1B, plate 10 has tapered hole 11 and hollow cylindrical caulking portion 12 extending from a periphery of tapered hole 11 on one side surface of plate 10. Plate 20 has insertion hole 21 for receiving caulking portion 12 of plate 10. Plates 10 and 20 are connected with each other by inserting caulking portion 12 of plate 10 into insertion hole 21 of plate 20 and overlaying plate 20 on plate 10, and then caulking a tip end portion of caulking portion 12 which projects from insertion hole 21, so as to fold back the tip end portion of caulking portion 12 over a periphery of insertion hole 21 on one side surface of plate 20.

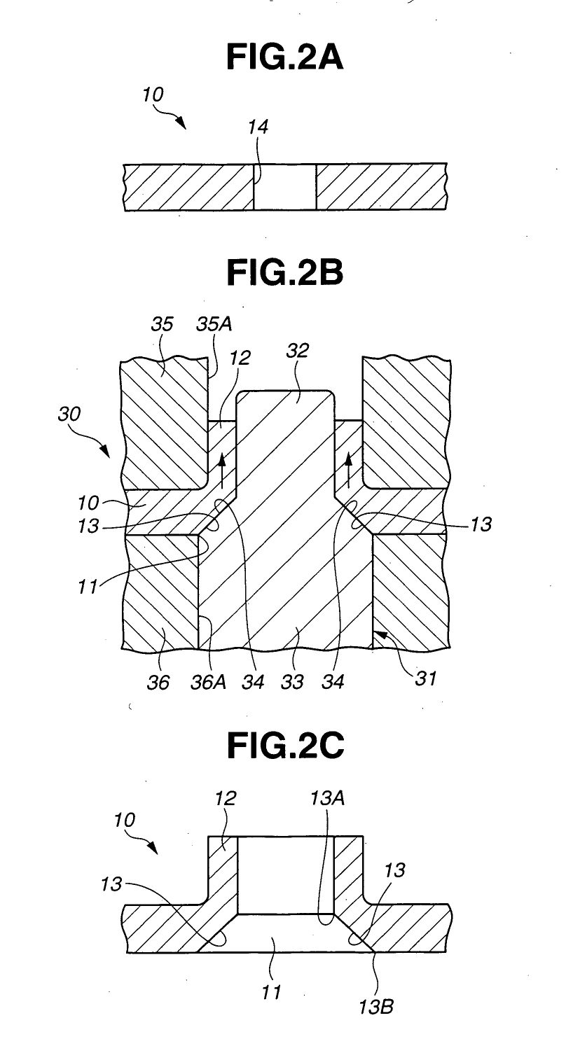

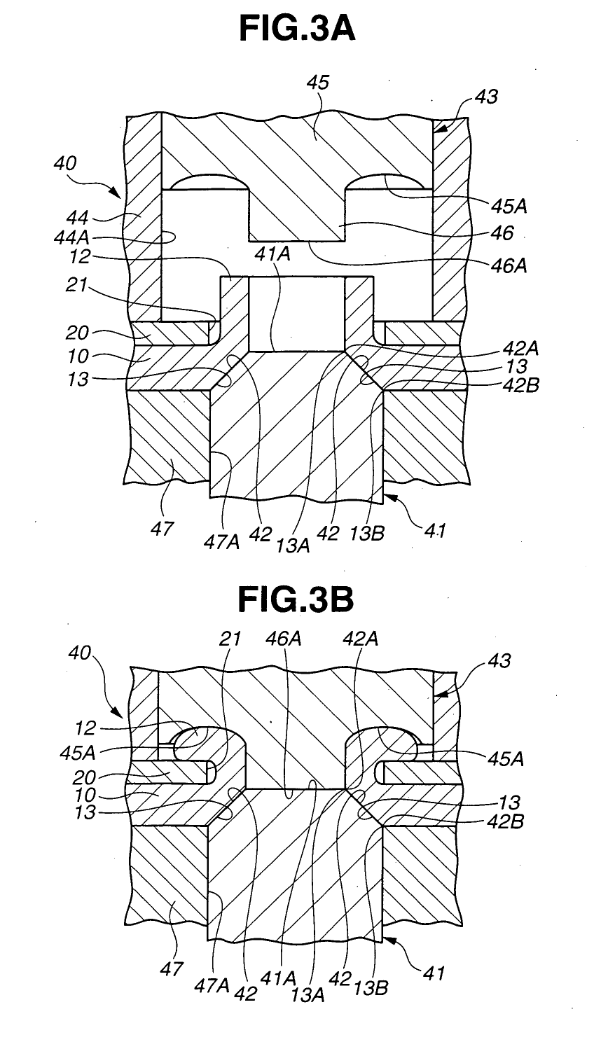

Referring to FIGS. 2A-2C and 3A-3B, a caulking method of joining plates 10 and 20 and a caulking apparatus used in the caulking method, of a first embodiment of the present invention, will be explained hereinafter. FIGS. 2A-2C show a burring operation of the caulking method and burring unit 30 of the caulking apparatus. FIGS. 3A-3B show a caulking operation of the caulking method and caulking unit 40 of the caulking apparatus. The caulking apparatus is thus constituted of burring unit 30 and caulking unit 40.

As illustrated in FIG. 2A, plate 10 as a workpiece has hole 14 into which burring punch 31 of burring unit 30 is pushed as shown in FIG. 2B. Burring unit 30 is in the form of a press machine including upper and lower dies moveable relative to each other. As illustrated in FIG. 2B, the upper die includes burring die 35, and the lower die includes burring punch 31 and retainer 36. Specifically, burring punch 31 has small-diameter portion 32, large-diameter portion 33 connected with small-diameter portion 32, and shoulder portion 34 disposed between small-diameter portion 32 and large-diameter portion 33. Small-diameter portion 32 serves for forming hollow cylindrical caulking portion 12 of plate 10. Shoulder portion 34 has a tapered surface that is tapered toward small-diameter portion 32 and has an inclination relative to an axis of burring punch 31. Shoulder portion 34 thus has a small-diameter side edge on a side of small-diameter portion 32 and a large-diameter side edge on a side of large-diameter portion 33. Burring die 35 has insertion hole 35A into which small-diameter portion 32 of burring punch 31 is inserted. Retainer 36 supports plate 10 thereon and has guide hole 36A for guiding large-diameter portion 33 of burring punch 31. Insertion hole 35A and guide hole 36A are so arranged as to be substantially in axial alignment with each other when burring die 35 and retainer 36 are held in place in an axially opposed relation to each other. Burring punch 31 is moveable in the axial direction thereof within guide hole 36A of retainer 36. Shoulder portion 34 of burring punch 31 is formed in such a position as to press against a periphery of one end portion of hole 14 of plate 10 when shoulder portion 34 is pushed into hole 14 through guide hole 36A of retainer 36. Shoulder portion 34 serves for forming beveled surface 13 that defines tapered hole 11, as shown in FIG. 2C. Beveled surface 13 is tapered toward a bore of caulking portion 12 and has a section having a linear and inclined contour inclined relative to a center axis of caulking portion 12. Beveled surface 13 has inside edge 13A on a small-diameter side thereof and outside edge 13B on a large-diameter side thereof. Inside edge 13A is formed by the small-diameter side edge of shoulder portion 34, and outer edge 13B is formed by the large-diameter side edge of shoulder portion 34.

Caulking unit 40 shown in FIGS. 3A-3B is in the form of a press machine including upper and lower dies moveable relative to each other. As illustrated in FIGS. 3A-3B, the upper die includes caulking punch 43 and upper retainer 44, and the lower die includes support die 41 and lower retainer 47. Specifically, upper retainer 44 has guide hole 44A for guiding caulking punch 43 therein. Caulking punch 43 includes small-diameter portion 46, large-diameter portion 45 connected with small-diameter portion 46, and a shoulder portion between small-diameter portion 46 and large-diameter portion 45. Small-diameter portion 46 is inserted into the bore of caulking portion 12 of plate 10. Large-diameter portion 45 is guided into guide hole 44A of upper retainer 44 along a guide surface surrounding guide hole 44A. Guide surface 45A is formed on the shoulder portion. Guide surface 45A serves for guiding the tip end portion of caulking portion 12 of plate 10 which projects beyond insertion hole 21 so as to orient the tip end portion of caulking portion 12 toward the one side surface of plate 20 when the tip end portion of caulking portion 12 is folded back over the periphery of caulking portion 12 as shown in FIG. 3B. Guide surface 45A has an arcuate section which may be in the form of a recess. Small-diameter portion 46 has abutment surface 46A coming into contact with receiving surface 41A of support die 41. Caulking punch 43 is disposed substantially in axial alignment with support die 41 and axially moveable relative thereto within guide hole 44A of upper retainer 44. Caulking punch 43 and support die 41 cooperate with each other to fold back the tip end portion of caulking portion 12 of plate 10 which projects beyond hole 21 of plate 20, over the periphery of hole 21 of plate 20 on the one side surface thereof, while pressing against beveled surface 13 of plate 10 so as to prevent a material of caulking portion 12 from flowing toward the other side surface of plate 10 along the periphery of tapered hole 11.

Lower retainer 47 retains plate 10 and plate 20 which overlap each other. Lower retainer 47 has guide hole 47A for guiding support die 41 thereinto. Guide hole 47A of lower retainer 47 and guide hole 44A of upper retainer 44 are so arranged as to be substantially in axial alignment with each other when upper retainer 44 and lower retainer 47 are held in place in an opposed relation to each other. Support die 41 is so disposed as to be moveable in an axial direction thereof within guide hole 47A of lower retainer 47. Support die 41 includes tapered portion 42 which has the same shape as that of tapered hole 11 of plate 10 so as to be engaged with beveled surface 13 surrounding tapered hole 11. Specifically, tapered portion 42 has an inclined surface relative to a central axis of support die 41. The inclined surface has an inclination equivalent to that of beveled surface 13, namely, equivalent to the inclination of shoulder portion 34 of burring punch 31. As illustrated in FIG. 3A, tapered portion 42 has small-diameter side edge 42A coming into engagement with inside edge 13A of beveled surface 13 of plate 10, and large-diameter side edge 42B coming into engagement with outside edge 13B of beveled surface 13 of plate 10 upon the caulking operation.

The method of joining plate 10 and plate 20 by using the caulking apparatus of the first embodiment will be explained hereinafter. The method includes a burring operation using burring unit 30 and a caulking operation using caulking unit 40. Upon the burring operation as shown in FIG. 2B, burring die 35 and retainer 36 are axially moved closer to each other so as to support plate 10 as the workpiece therebetween. At this time, plate 10 is held in a position where hole 14 of plate 10 is substantially in axial alignment with burring punch 31.

Next, burring punch 31 is upwardly moved toward plate 10 such that small-diameter portion 32 is pushed into hole 14 of plate 10 and then moved into insertion hole 35A of burring die 35 as shown in FIG. 2B. Burring punch 31 is further upwardly moved until caulking portion 12 of plate 10 is formed with the cooperation of small-diameter portion 32 and burring die 35, and tapered hole 11 of plate 10 is formed with the cooperation of shoulder portion 34 and burring die 35, as shown in FIG. 2B.

During the upward movement of burring punch 31, a material of the periphery of hole 14 of plate 10 undergoes plastic deformation between an outer circumferential surface of small-diameter portion 32 of burring punch 31 and a circumferential periphery of insertion hole 35A of burring die 35. As a result, hollow cylindrical caulking portion 12 of plate 10 is formed on the one side surface of plate 10. As burring punch 31 is further upwardly moved, shoulder portion 34 of burring punch 31 is pressed against the periphery of the one end portion of hole 14 of plate 10 as shown in FIG. 2B. The periphery of the one end portion of hole 14 of plate 10 undergoes coining and thereby is formed into beveled surface 13. Thus, tapered hole 11 defined by beveled surface 13 is formed. During the pressing operation of shoulder portion 34 of burring punch 31 against the periphery of the one end portion of hole 14, the material of the periphery of the one end portion of hole 14 is caused to flow toward the tip end side of caulking portion 12 as indicated by arrows shown in FIG. 2B. Therefore, even when hole 14 having a relatively small diameter is subjected to the burring operation of the method of the first embodiment, a sufficient height or dimension of caulking portion 12 which extends from the one side surface of plate 10 can be ensured unlike the conventional burring operation in which no or less material of the periphery of the one end portion of hole 14 flows toward the tip end portion of caulking portion 12. Further, according to the burring operation of the caulking method of the first embodiment, the height of caulking portion 12 can be kept, and the tip end portion of caulking portion 12 can be prevented from suffering from hair crack and further occurrence of cracks during the subsequent caulking operation as explained later. This results in increase in joining strength.

After completion of the upward movement, burring punch 31 is then downwardly moved and retreated from tapered hole 11 of plate 10. Then, burring die 35 and retainer 36 are axially moved away from each other, and plate 10 formed with tapered hole 11 and caulking portion 12 is taken out. The burring operation is thus accomplished.

Subsequently, caulking portion 12 of plate 10 is inserted through insertion hole 21 of plate 20 to project the tip end portion of caulking portion 12 beyond insertion hole 21, and thus plate 20 is overlaid on plate 10. Thus-overlapping plates 10 and 20 are subjected to caulking as shown in FIGS. 3A-3B. Upon the caulking operation, first, as shown in FIG. 3A, upper and lower retainers 44 and 47 are moved closer to each other so as to support overlapping plates 10 and 20 between upper and lower retainers 44 and 47. At this time, overlapping plates 10 and 20 is held in a position where caulking portion 12 of plate 10 is substantially in axial alignment with support die 41 and caulking punch 43.

Next, support die 41 is upwardly moved such that tapered portion 42 is pressed against beveled surface 13 surrounding tapered hole 11 of plate 10. Tapered portion 42 is engaged with beveled surface 13 as shown in FIG. 3A. In this engaged state, small-diameter side edge 42A of tapered portion 42 is aligned with inside edge 13A of beveled surface 13 of plate 10, and large-diameter side edge 42B of tapered portion 42 is aligned with outside edge 13B of beveled surface 13 of plate 10. While keeping the engaged state of tapered portion 42 and beveled surface 13, caulking punch 43 is downwardly moved toward caulking portion 12 of plate 10 such that small-diameter portion 46 is inserted into the bore of caulking portion 12. As caulking punch 43 is further downwardly moved and small-diameter portion 46 is inserted into the bore of caulking portion 12, the tip end portion of caulking portion 12 is radially outwardly expanded along guide surface 45A of caulking punch 43. When small-diameter portion 46 abuts on receiving surface 41A of support die 41 as shown in FIG. 3B, caulking portion 12 is folded back over the periphery of insertion hole 21 on the one side surface of plate 20. The tip end portion of caulking portion 12 is thus caulked onto the periphery of insertion hole 21 of plate 20, so that overlapping plates 10 and 20 are joined with each other.

Subsequently, caulking punch 43 is upwardly moved and retreated from caulking portion 12 of plate 10, and support die 41 is downwardly moved and retreated from tapered hole 11 of plate 10. Then, upper and lower retainers 44 and 47 are moved away from each other, and joined plates 10 and 20 are taken out. The caulking operation is thus accomplished.

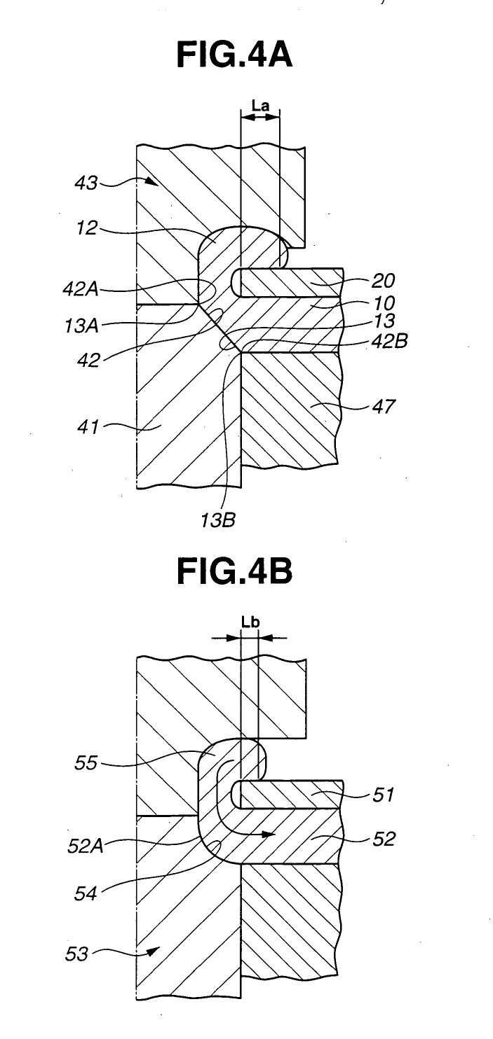

Referring to FIGS. 4A and 4B, functions and effects of the method of the above-described first embodiment are explained as compared to those of a comparative example. FIG. 4B illustrates a schematic enlarged view of parts of plates 51 and 52 joined with each other in the comparative example. As shown in FIG. 4B, plate 52 includes a hole defined by curved surface 52A and caulking portion 55 extending from a periphery of the hole on one side surface of plate 52. Curved surface 52A is formed by a conventional burring operation. Curved surface 52A has an arcuate section and continuously and smoothly connected with an inner circumferential surface of caulking portion 55 and the other side surface of plate 52. There is no edges between curved surface 52A and the inner circumferential surface of caulking portion 55 and between curved surface 52A and the other side surface of plate 52. Upon the caulking operation, support die 53 having recessed portion 54 is used. Recessed portion 54 has such a shape as to engage curved surface 52A surrounding the hole of plate 52. When recessed portion 54 of support die 53 is pressed against curved surface 52A of plate 52 upon the caulking operation, a material of caulking portion 55 of plate 52 is caused to flow from a tip end side of caulking portion 55 toward the other side surface of plate 52 along a periphery of the hole of plate 52 as indicated by arrow shown in FIG. 4B. This results in reduction of lapping amount Lb of caulking portion 55 which is obtained by the caulking operation.

In contrast, according to the method of the first embodiment as shown in FIG. 4A, beveled surface 13 defining tapered hole 11 of plate 10 is formed by the burring operation. Beveled surface 13 is tapered toward caulking portion 12 of plate 10 and has a linear and inclined contour in section. Beveled surface 13 has inside edge 13A on the small-diameter side thereof, namely, on the side of caulking portion 12, and outside edge 13B on the large-diameter side thereof. With this arrangement, the material of caulking portion 12 on the one side surface of plate 10 can be effectively prevented from flowing toward the other side surface of plate 10 along the periphery of tapered hole 11, as compared to the comparative example. This suppresses reduction of lapping amount La of caulking portion 12 of plate 10, serving for ensuring a necessary joining strength of plates 10 and 20.

In addition, upon the caulking operation of the method of the first embodiment as shown in FIG. 4A, support die 41 having tapered portion 42 is used. Tapered portion 42 of support die 41 has small-diameter side edge 42A and large-diameter side edge 42B which are engageable with inside edge 13A and outside edge 13B of beveled surface 13 of plate 10, respectively. With the provision of small-diameter side edge 42A and large-diameter side edge 42B, the shapes of inside edge 13A and outside edge 13B of beveled surface 13 can be surely retained, and the effect of preventing the material flow of caulking portion 12 of plate 10 toward the other side surface thereof upon the caulking operation can be ensured.

Specifically, inside edge 13A and outside edge 13B of beveled surface 13 of plate 10 and small-diameter side edge 42A and large-diameter side edge 42B of tapered portion 42 of support die 41 are provided in order to achieve the effect of suppressing the material flow of caulking portion 12 of plate 10 upon the caulking operation. From the viewpoint of accuracy of forming shoulder portion 34 of burring punch 31 and tapered portion 42 of support die 41, inside edge 13A and outside edge 13B and small-diameter side edge 42A and large-diameter side edge 42B may be rounded as microscopically viewed. Even in such a case, the material flow of caulking portion 12 of plate 10 upon the caulking operation can be sufficiently suppressed, as compared to the comparative example shown in FIG. 4B. Accordingly, the “edge” used in the description can have all of shapes that can prevent the material of caulking portion 12 of plate 10 from flowing toward the other side surface thereof along the periphery of tapered hole 11. For instance, the shapes may be a sharp ridge shape formed by two intersecting planes, and a microscopically rounded shape.

The inclination of shoulder portion 34 of burring punch 31 and tapered portion 42 of support die 41 may not be limited to a specific value. However, it is preferred to adjust the inclination of shoulder portion 34 and tapered portion 42 to about 45 degrees in order to obtain a good balance between the effect of allowing the material flow directed toward the one side surface of plate 10 upon the burring operation and the effect of suppression of the material flow directed from caulking portion 12 of plate 10 toward the other side surface thereof along the periphery of tapered hole 11 upon the caulking operation.

Further, for the purpose of suppressing the material flow of caulking portion 12 of plate 10 upon the caulking operation, it is effective to form fine recesses and projections on beveled surface 13 of plate 10 and the inclined surface of tapered portion 42 of support die 41 or roughen beveled surface 13 and the inclined surface of tapered portion 42.

Meanwhile, if a stepped portion is formed on beveled surface 13 of plate 10 upon the burring operation in order to prevent the material flow of caulking portion 12 upon the caulking operation, a thickness of plate 10 will be reduced at the stepped portion. This causes stress concentration around the stepped portion, whereby sufficient joining strength cannot be ensured. Therefore, it is preferred that beveled surface 13 has the linear and inclined contour in section as explained above.

In the first embodiment as explained above, while pressing tapered portion 42 of support die 41 against beveled surface 13 defining tapered hole 11 of plate 10, caulking portion 12 of plate 10 is caulked to plate 20. Upon the caulking operation, the material of caulking portion 12 can be prevented from flowing toward the other side surface of plate 10 along the periphery of tapered hole 11. Therefore, even in a case where a reduced-diameter side of tapered hole 11, namely, the bore of caulking portion 12 has a relatively small diameter, sufficient lapping amount La of caulking portion 12 can be effectively attained and sufficient joining strength of plates 10 and 20 can be obtained. Accordingly, even when a diameter of the reduced-diameter side of tapered hole 11 of plate 10 must be set relatively small in view of layout of a finished product and strength of the finished product as a whole, the caulking operation can be suitably performed.

Further, upon the burring operation prior to the caulking operation, caulking portion 12 and beveled surface 13 of plate 10 can be readily formed by small-diameter portion 32 and shoulder portion 34 of burring punch 31, respectively.

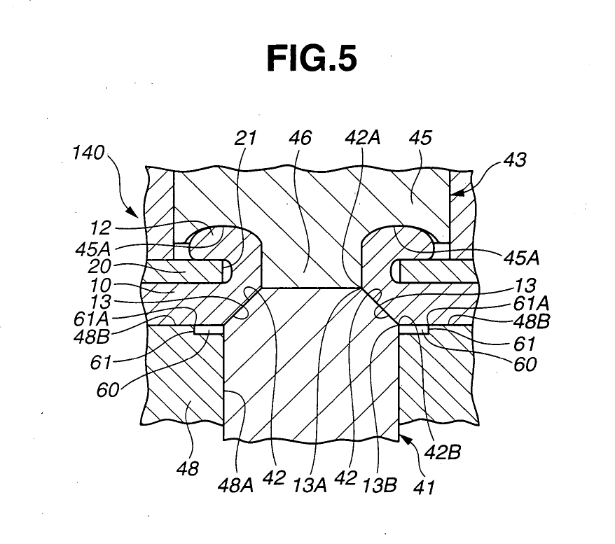

Referring to FIG. 5, a calking method for joining plates and a caulking apparatus used in the calking method, according to a second embodiment of the present invention, will be explained hereinafter. The second embodiment differs in the caulking operation and the caulking unit of the caulking apparatus from the first embodiment. Since the burring operation and the burring unit in this embodiment are the same as those of the first embodiment, detailed explanations therefor are omitted. As illustrated in FIG. 5, caulking unit 140 includes lower retainer 48 having support surface 48B on which overlapping plates 10 and 20 are retained such that a lower surface of plate 10 is contacted with support surface 48B. Lower retainer 48 includes guide hole 48A for guiding support die 41 and recess 60 open to guide hole 48A. Recess 60 is radially inwardly disposed on support surface 48B. Stepped portion 61 is formed between support surface 48B and a bottom of recess 60. Edge 61A is formed at a boundary between support surface 48B and stepped portion 61. Edge 61A is engaged with the lower surface of plate 10 to thereby prevent the material of caulking portion 12 of plate 10 from flowing toward an upper side surface of plate 10 along the periphery of tapered hole 11 upon the caulking operation. A depth of recess 60, namely, a height of stepped portion 61 is 1 mm or less, preferably, about 0.5 mm. A radial length of recess 60 may be several millimeters.

Caulking unit 140 are thus formed with edge 61A of lower retainer 48 in addition to small-diameter side edge 42A and large-diameter side edge 42B of tapered portion 42 of support die 41. Thus, with the provision of edge 61A of lower retainer 48, the flow of the material of caulking portion 12 of plate 10 toward the upper side surface thereof along the periphery of tapered hole 11 upon the caulking operation can be more effectively prevented. This attains more sufficient lapping amount La of caulking portion 12 and more increased joining strength of plates 10 and 20 even if tapered hole 11 has a relatively small diameter. Accordingly, even when a diameter of the reduced-diameter side of tapered hole 11, namely, a diameter of the bore of caulking portion 12 must be set relatively small in view of layout of a finished product and strength of the finished product as a whole, the caulking operation can be suitably performed.

Further, the formation of caulking portion 12 and beveled surface 13 of plate 10 is not limited to burring, i.e., punching as explained the above-described embodiments, and may be performed by forging.

This application is based on prior Japanese Patent Application No. 2004-092928 filed on Mar. 26, 2004. The entire contents of the Japanese Patent Application No. 2004-092928 is hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

1. A caulking method for joining a first plate having a tapered hole tapered toward one side surface thereof and defined by a beveled surface, and a hollow cylindrical caulking portion extending from a periphery of the tapered hole on the one side surface thereof, and a second plate having a hole, the caulking method comprising:
inserting the hollow cylindrical caulking portion of the first plate through the hole of the second plate to project a tip end portion of the hollow cylindrical caulking portion beyond the hole and overlay the second plate on the first plate; and
folding back the tip end portion of the hollow cylindrical caulking portion of the first plate over a periphery of the hole of the second plate on one side surface thereof, while pressing against the beveled surface of the first plate so as to prevent a material of the hollow cylindrical caulking portion from flowing toward the other side surface of the first plate along the periphery of the tapered hole.

2. The caulking method as claimed in claim 1, wherein the beveled surface has an inside edge on a small-diameter side thereof and an outside edge on a large-diameter side thereof, and the pressing against operation comprises engaging with the inside edge and the outside edge of the beveled surface.

3. The caulking method as claimed in claim 2, wherein the pressing against operation further comprises engaging with the other side surface of the first plate.

4. The caulking method as claimed in claim 1, wherein the folding back operation comprises guiding the tip end portion of the hollow cylindrical caulking portion of the first plate so as to orient the tip end portion of the hollow cylindrical caulking portion toward the one side surface of the second plate.

5. The caulking method as claimed in claim 1, further comprising subjecting a workpiece having a hole to burring to provide the beveled surface and the hollow cylindrical caulking portion of the first plate.

6. The caulking method as claimed in claim 5, wherein the burring operation comprises punching the workpiece to push a material of the workpiece around the hole toward the one side surface to form the hollow cylindrical caulking portion of the first plate.

7. The caulking method as claimed in claim 1, further comprising subjecting a workpiece having a hole to forging to provide the beveled surface and the hollow cylindrical caulking portion of the first plate.

8. A caulking apparatus for joining a first plate having a tapered hole tapered toward one side surface thereof and defined by a beveled surface with an inside edge and an outside edge, and a hollow cylindrical caulking portion extending from a periphery of the tapered hole on the one side surface thereof, and a second plate having a hole, the caulking apparatus comprising:
a caulking unit comprising:
a caulking punch axially moveably disposed; and
a support die having a tapered portion for pressing against the beveled surface of the first plate, the support die being disposed substantially in axial alignment with the caulking punch and axially moveable to be inserted into the tapered hole of the first plate,
the caulking punch and the support die cooperating with each other to fold back a tip end portion of the hollow cylindrical caulking portion which projects beyond the hole of the second plate, over a periphery of the hole of the second plate on the one side surface thereof, while pressing against the beveled surface of the first plate so as to prevent a material of the hollow cylindrical caulking portion from flowing toward the other side surface of the first plate along the periphery of the tapered hole.

9. The caulking apparatus as claimed in claim 8, wherein the tapered portion of the support die comprises a small-diameter side edge and a large-diameter side edge which are engageable with the inside edge and the outside edge of the beveled surface of the first plate, respectively.

10. The caulking apparatus as claimed in claim 8, wherein the caulking punch further comprises a small-diameter portion, a large-diameter portion connected with the small-diameter portion, and a shoulder portion between the small-diameter portion and the large-diameter portion, the small-diameter portion being adapted to be inserted into a bore of the hollow cylindrical caulking portion of the first plate.

11. The caulking apparatus as claimed in claim 10, wherein the caulking punch further comprises a guide surface formed on the shoulder portion, the guide surface being adapted for guiding the tip end portion of the hollow cylindrical caulking portion of the first plate so as to orient the tip end portion of the hollow cylindrical caulking portion toward the one side surface of the second plate.

12. The caulking apparatus as claimed in claim 10, wherein the caulking unit further comprises a retainer having a guide hole for guiding the large-diameter portion of the caulking punch.

13. The caulking apparatus as claimed in claim 8, wherein the caulking unit further comprises a retainer for retaining the first plate and the second plate overlapping each other, the retainer having a support surface adapted to be in contact with the other side surface of the first plate and a guide hole for guiding the support die.

14. The caulking apparatus as claimed in claim 13, wherein the retainer has a recess radially inwardly formed on the support surface and open to the guide hole, a stepped portion between the support surface and a bottom of the recess, and an edge between the stepped portion and the support surface, the edge of the retainer being engageable with the other side surface of the first plate.

15. The caulking apparatus as claimed in claim 8, further comprising a burring unit for subjecting a workpiece having a hole to burring, the burring unit comprising a burring punch axially moveable and having a small-diameter portion, a large-diameter portion connected with the small-diameter portion, and a shoulder portion disposed between the small-diameter portion and the large-diameter portion and tapered toward the small-diameter portion, the small-diameter portion being adapted to be pushed into the hole of the workpiece to form the hollow cylindrical caulking portion of the first plate, the shoulder portion being adapted to press against a periphery of the hole of the workpiece to form the beveled surface of the first plate.

16. The caulking apparatus as claimed in claim 15, wherein the burring unit further comprises a burring die disposed substantially in axial alignment with the burring punch, the burring die cooperating with the burring punch to form the hollow cylindrical caulking portion and the beveled surface of the first plate.
